(19) United States
(12) Patent Application Publication
(10) Pub. No.: US 2026/0163930 A1
(43) Pub. Date: Jun. 11, 2026

(54) SIDE CONVERSATIONS FOR VIDEO FAMILY MEETINGS

(71) Applicant: AT&T Intellectual Property I, L.P., Atlanta, GA (US)

(72) Inventors: James H. Pratt, Round Rock, TX (US); Inderpreet Singh Ahluwalia, Austin, TX (US); Gregory W. Edwards, Austin, TX (US); Eric Zavesky, Austin, TX (US)

(73) Assignee: AT&T Intellectual Property I, L.P., Atlanta, GA (US)

(21) Appl. No.: 18/973,848

(22) Filed: Dec. 9, 2024

(51) Int. Cl. H04L 65/401; G06V 40/16

(52) U.S. Cl. CPC H04L 65/401; G06V 40/176

(57) ABSTRACT

Aspects of the subject disclosure may include, for example, identifying, by the processing system, a facial representation of the first user in a video portion of the first media presentation, analyzing, by the processing system, the facial representation of the first user, detecting, by the processing system, an event, wherein the detecting the event is based on the analyzing the facial representation of the first user, determining, by the processing system, a modification of the first media presentation of the first user, wherein the determining the modification is based on the detecting the event, modifying, by the processing system, the first media presentation of the first user according to the modification, forming a modified media presentation, and communicating, by the processing system, the modified media presentation to a second user. Other embodiments are disclosed.

### FIELD OF THE DISCLOSURE

The subject disclosure relates to a system and method for users to have an efficient means by which to conduct spoken side conversations when conducting a multi-party video call.

### BACKGROUND

A problem exists in that users do not currently have a good means by which to conduct spoken side conversations when conducting a multi-party video call. This may be the case, for example, for family members or professional colleagues using personal electronic devices or applications when having a video meeting together.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a method of operating the system of FIG. 2A.

FIG. 2C is a block diagram illustrating a second example, non-limiting embodiment of a system functioning within the communication network of FIG. 1 in accordance with various aspects described herein.

FIG. 2D is a block diagram illustrating an example, non-limiting embodiment of a method of operating the system of FIG. 2C.

FIG. 2E is a block diagram illustrating a second exemplary, non-limiting embodiment of a method of operating the system of FIG. 2C.

FIG. 2F is a block diagram illustrating a third exemplary, non-limiting embodiment of a method of operating the system of FIG. 2C.

FIG. 2G is a block diagram illustrating a third exemplary, non-limiting embodiment of a method of operating the system of FIG. 2C.

FIG. 2H depicts an illustrative embodiment of a first method in accordance with various aspects described herein.

FIG. 2I depicts an illustrative embodiment of a first method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a system and method for conducting spoken side conversations during multi-party video calls by analyzing a user's eye movements to direct the conversation to a specific participant. The system uses a media server to manage video streams, detect facial expressions, and track gaze direction, ensuring private communication between selected users. Additionally, the system can modify media presentations by replacing inattentive or undesired expressions with pre-stored segments to maintain an attentive appearance. Other embodiments are described in the subject disclosure.

One or more aspects of the subject disclosure include identifying a facial representation of the first user in a video portion of the first media presentation, analyzing the facial representation of the first user, detecting an event, wherein the detecting the event is based on the analyzing the facial representation of the first user, determining a modification of the first media presentation of the first user, wherein the determining the modification is based on the detecting the event, modifying the first media presentation of the first user according to the modification, forming a modified media presentation, and communicating the modified media presentation to a second user.

One or more aspects of the subject disclosure include initiating a multi-party video call including at least a first user, a second user and a third user, communicating respective media presentations to a media device of each respective user of the first user, the second user and the third user, identifying one or more designated portions of a video display of a respective media device of each respective user, each designated portion of the video display presenting a facial representation of another respective user of the first user, the second user and the third user, detecting a cue of the first user to initiate a communication with the second user, the cue indicating a side conversation utterance from the first user to the second user and excluding the third user, detecting, from the first user, the side conversation utterance, wherein the detecting is responsive to the detecting the cue of the first user, and communicating information of the side conversation utterance to a media device of the second user.

One or more aspects of the subject disclosure include receiving a first media presentation of a first user, identifying a facial representation of the first user in a video portion of the first media presentation, identifying a baseline facial representation of the first user for storage as a reference image of the first user, analyzing the facial representation of the first user during presentation of the first media presentation, identifying an event in the presentation of the first media presentation, wherein the identifying the event the event is based on the analyzing the facial representation of the first user, based on an identification of the event, modifying the video portion of the first media presentation, forming a modified media presentation, and communicating the modified media presentation to a second user.

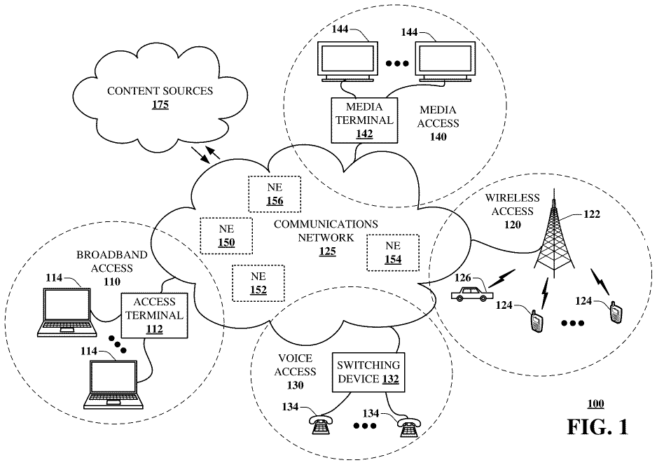

Referring now to FIG. 1, a block diagram is shown illustrating an example, non-limiting embodiment of a system 100 in accordance with various aspects described herein. For example, system 100 can facilitate in whole or in part conducting spoken side conversations during multi-party video calls by analyzing a user's eye movements to direct the conversation to a specific participant In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

The invention can be implemented within the communications network 125 depicted in FIG. 1, which integrates various access methods such as broadband access 110, wireless access 120, voice access 130, and media access 140. The network elements (NE) 150, 152, 154, and 156 facilitate the distribution of content from content sources 175 to various devices like data terminals 114, mobile devices 124, telephony devices 134, and audio/video display devices 144. This setup allows for the seamless integration and communication necessary for conducting multi-party video calls and managing side conversations as described in the invention.

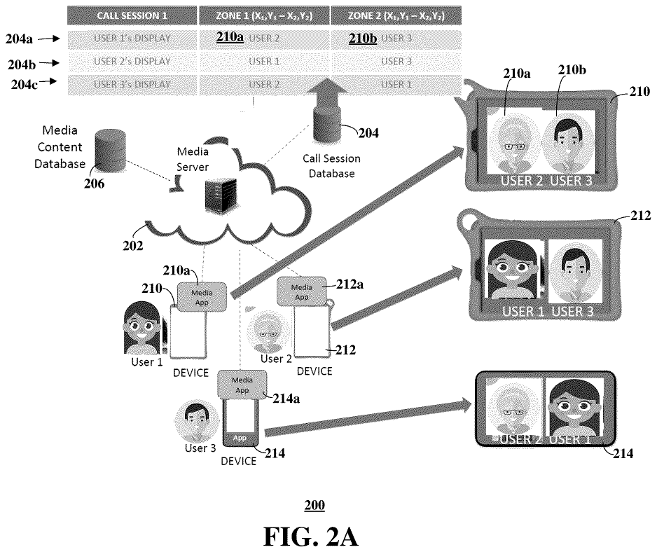

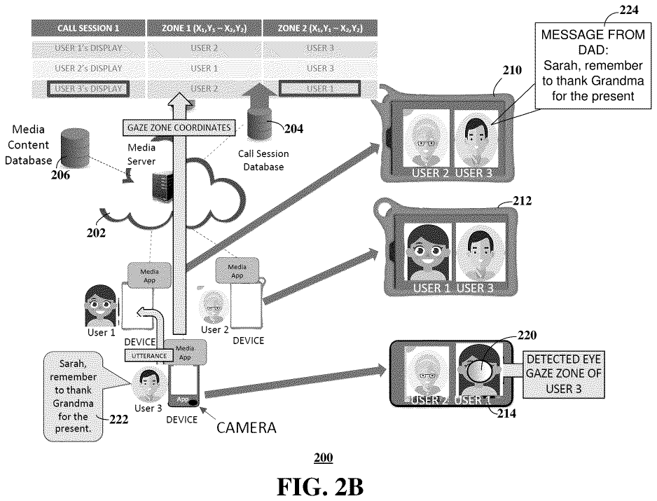

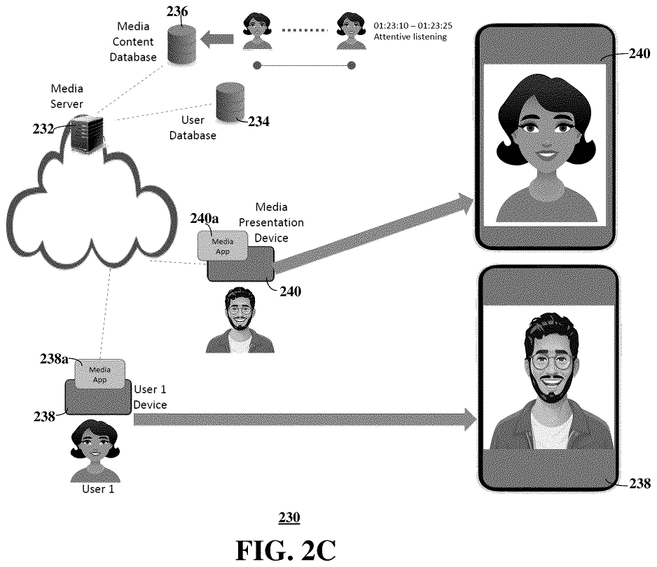

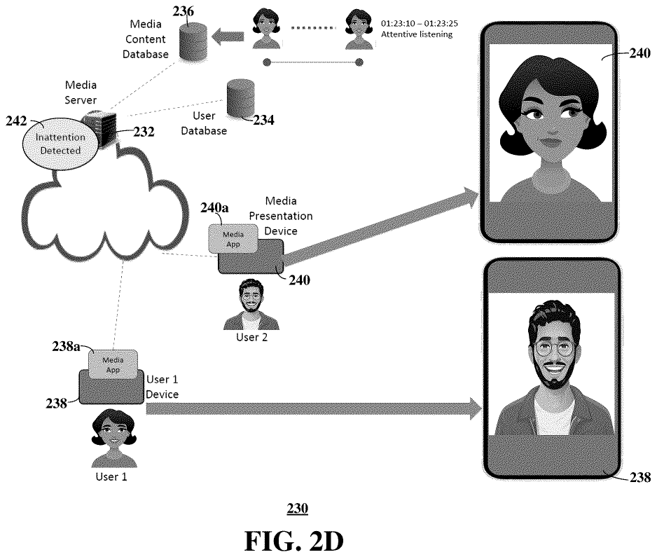

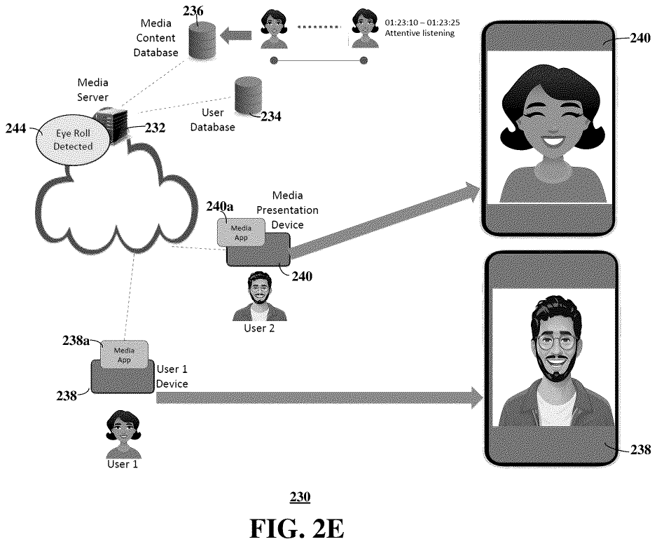

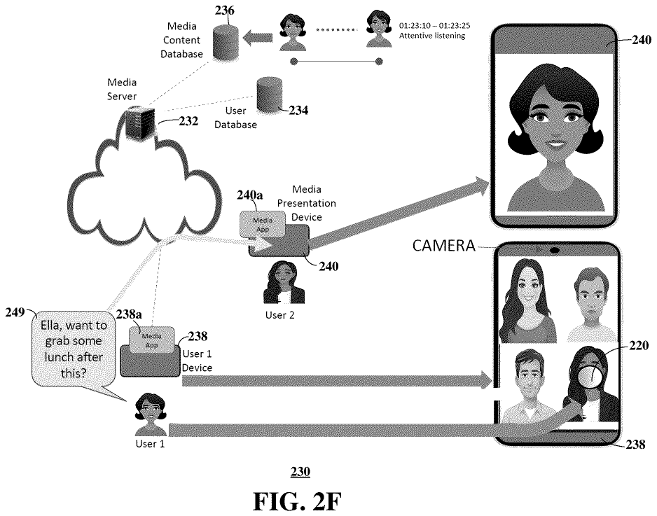

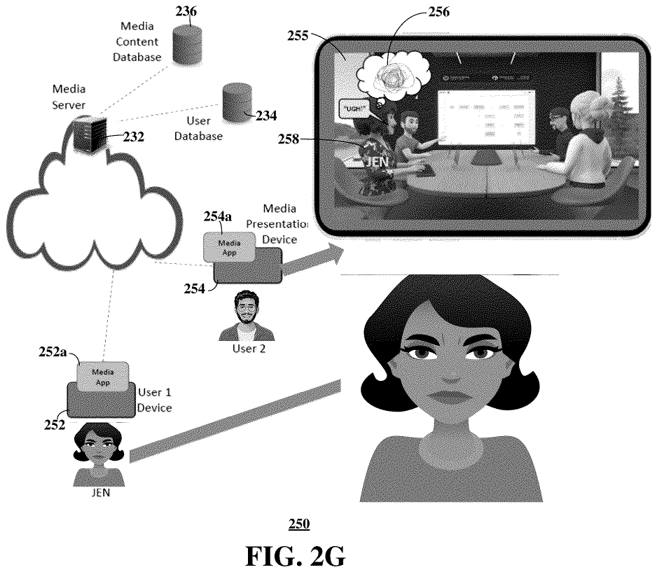

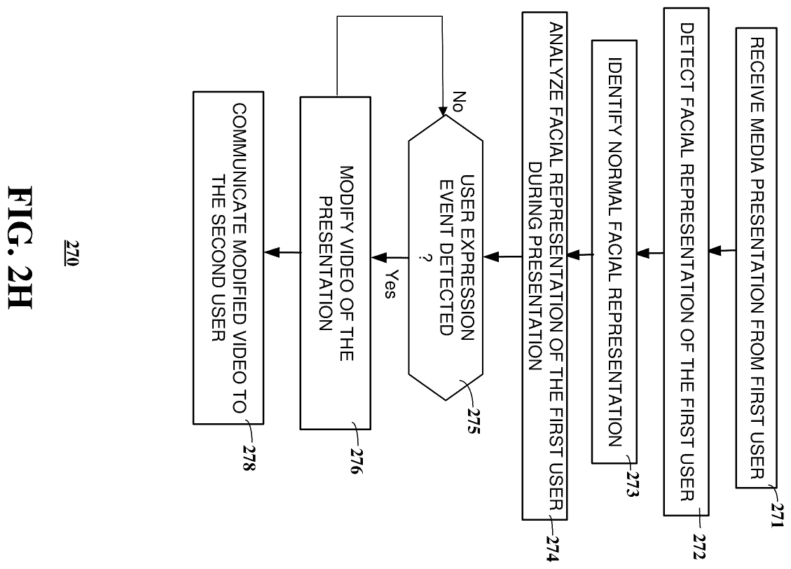

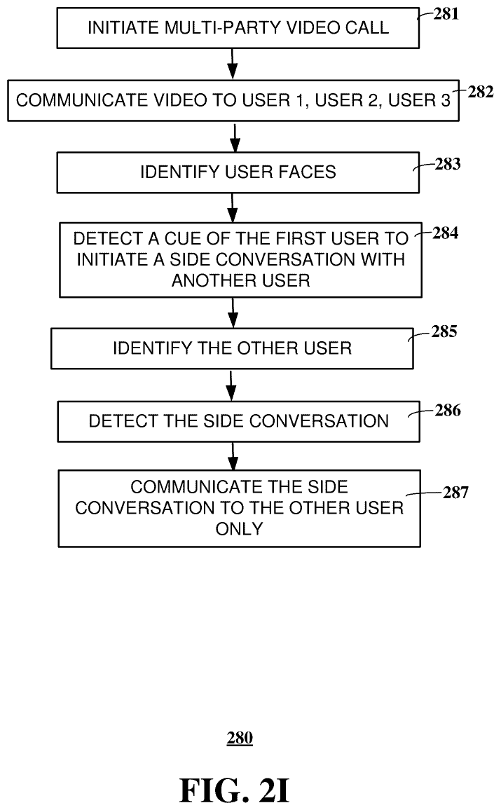

FIG. 2A is a block diagram illustrating an example, non-limiting embodiment of a system functioning within the communication network of FIG. 1 in accordance with various aspects described herein. FIG. 2A illustrates a system 200 functioning within the communication network 125 of FIG. 1. The system 200 includes a media server 202, which is a central component responsible for managing media streams and interactions between users during a multi-party video call.

The media server 202 is connected to and in data communication with a media content database 206 and a call session database 204. The media content database 206 stores various media assets, such as video segments, audio clips, and other multimedia content that may be collected from the participants in the video call during the video call, and that can be used during the video call.

The call session database 204 maintains records of each call session. In the illustrated embodiment, the call session database 204 stores records such as record 204a, record 204b and record 204c. Each respective record of the database 204 may include user identification information for each participant or user involved in a call session or video call as well as display coordinates and other metadata necessary for managing the video call. The display coordinates relate to where on a user device display an image of another participant in the call or user is displayed.

User1, user2, and user3 are each associated with user device 210, user device 212, and user device 214, respectively. The respective user devices may be embodied as a particular user device customized for operation with the system 200 to participating in video calls and other activities. User device 212 and user device 214 may be embodied in this manner. In other example embodiments, the user devices may be embodied as a general-purpose user device including an application enabling cooperation with the system 200 to participate in video calls. User device 210 may be embodied in this manner. Such general purposes user devices may include smart phones, tablet computers, laptop computers, and other such devices.

Each user device is equipped with a media application program or app that enables the user to participate in the video call. In an example, the media app is provided by a service provider as part of a video call service offered by the service provider. Thus, in the example, user device 210 includes media app 210a, user device 212 includes media app 212a, and user device 210 includes media app 214a. Each media app may cooperate with a server application or other functions of the media server 202 for initiating and processing a video call. Some functional aspects described herein may be associated with the media server 202, the media app of each respective user device, or shared between the media server 202 and the user device.

Each media app further controls aspects of its respective user device such as providing a user interface for the user to interact with the user device during the video call. Thus, the user device may include a display device, a microphone, a touch screen or a keyboard or keypad. The display device provides to a user of the user device a video display of other participants in the video call, as captured by cameras associated with the user devices of the other participants. The display may be from a video feed from the media server 202, collected by the media server 202 from the user devices of the other participants in the video call. Further, the user device may include a camera and microphone for capturing images or a video feed of the user who is associated with the user device. The images or video feed, including audio data, may be communicated from the user device to the media server 202 for routing to other user devices of users participating in the video call.

Thus, the media apps are responsible for capturing the user's video and audio, transmitting it to the media server 202, and receiving and displaying the media streams from other users. The media apps also track the user's eye movements and facial expressions to facilitate side conversations and other interactive features. Any suitable technique for tracking user eye movements including the direction of the user's gaze may be implemented by the media apps.

The call session database 204 stores information about one or more video calls implemented by the system 200. The stored information may include information about subscribers to a video call service who may be participants in a video call. The stored information may include information received from users, information about the user devices such as user device 210, user device 212 and user device 214, and information including network address information, device capabilities and other information.

In accordance with some embodiments, during an active video call, each user device displays on a display device of the user an image of the other participants in the call. Thus, in the example of FIG. 2A, user device 210 is associated with user 1. The display of user device 210 includes an image 210a of user 2 and an image 210b of user 3. Similarly, the user device 212 associated with user 2 includes an image of user 1 and an image of user 3. Further, the user device 214 associated with user 3 includes an image of user 2 and an image of user 1. Thus, each user can see live video images of each of the other participants in the video call.

In this example three users participate in the video call. That is intended to be exemplary only. Any suitable number of participants may be part of the call. Further, in some embodiments, some participants may drop off the call and some new participants may join the call. The media server 202 receives from the respective user devices information about the participants in the video call Further the media server 202 tracks and maintains information about the respective participants and stores updated information in the call session database 204.

During an active video call, the call session database 204 may store display coordinates for each user's video representation on their respective screens. For example, in the illustrated embodiment for a call involving three participants, the call session database 204 stores three columns of data. The first column, labelled Call Session 1 to identify the active video call, stores information identifying the respective users and the respective user devices. In examples, the identification information may be tied to an identifier of a media app of a user device such as, the media app 210a of, for example, the user device 210. In other examples, the identification may be tied to a unique identifier of the user device such as an International Mobile Standard Identification number, or IMSI. In other examples, the identification may be tied to identification information of the user such as an account number with the service provider.

The display coordinates stored by the call session database 204 correspond to a portion of the screen on which a respective user image is positioned. In the call session database, this may be arranged in two columns labelled ZONE 1 (X1, Y1−X2, Y2) and ZONE 2 (X1, Y1−X2, Y2), respectively. Thus, in the example, the zone 1 values 210a stored in the call session database 204 in record 204a correspond to the values 210a for the display zone on the user device 210 of user 1 on which the image of user 2 is displayed. Similarly, the zone 2 values 210b of the call session database record 204a correspond to the values 210b for the display zone on the user device 210 of user 1 on which the image of user 3 is displayed.

Thus, the record 204a of the call session database 204 stores data which represent the areas on User 1's display where the video feeds of User 2 and User 3 are shown. Similarly, the record 204b of the call session database 204 stores data which represent the areas on User 2's display where the video feeds of User 1 and User 3 are shown. Further, the record 204c of the call session database 204 stores data which represent the areas on User 3's display where the video feeds of User 1 and User 2 are shown.

The number of records stored in the call session database 204 for a given video call will vary with the number of participants in the call. Any suitable manner for measuring and determining positioning data on the display screens of the user devices may be used. Such positioning data may depend on the brand and model of the user device, the relative size and proportions of the video display, and other factors. Processing of such position data may be readily handled by the media server 202. This information is used for determining which user another participant is looking at on the participants local display screen during the call, enabling the system to direct side conversation utterances accurately.

FIG. 2B is a block diagram illustrating an example, non-limiting embodiment of a method of operating the system 200 of FIG. 2A. The system 200 generally includes the same elements as illustrated in FIG. 2A and implements a video call between three users labelled user 1, user 2 and user 3. In the example, user 1 is a girl named Sarah, user 2 is her father and user 3 is her grandmother. The user devices of the three users are in data communication through the media server 232. The call session database 204 maintains data about the participants and the video call.

The media server 202 analyzes data forming the video streams from each user to detect facial expressions and eye movements of the users. User 3's camera is used not only for creating the media stream associated with user 3, but also for determining, via the media app 214a, an orientation of user 3's gaze on the screen of user 3's user device 214. This is useful in the case of a multi-party embodiment, as illustrated, such that it may be determined by the media app 214a which user of the multiple users is being viewed by user 3.

When User 3, for example, looks at User 2's video feed and speaks an utterance such as utterance 222, the media app 214a on User 3's user device 214 identifies the gaze direction and the spoken cue of utterance 222. In the example, the user device 214 includes a camera to capture images and the video stream of user 3 as user 3 participates in the video call. The media app 214a or the media server 202 determine the area of the display screen of the user device 214 at which user 3 is looking. User 3's camera, via the media app 214a, tracks user 3's eye movements and determines a gaze zone indicating a set of coordinates, or a range of coordinates, which represent user 3's focal point at a time t1. At the same time t1, user 3 speaks an utterance 222, as shown. In the example, user 3 says to his daughter user 1, in a side conversation that is not to be heard by user 2, her grandmother, “Sarah, remember to thank Grandma for the present.” By detecting the direction of the gaze of user 3 toward zone 1 or zone 2 of the display screen of his user device 214, the media app 214a or the media server determines to which other participant in the call, user 1 or user 2, the side conversation is directed.

In addition to, or instead of, detecting the direction of the user's gaze, a key action of the user may be used to distinguish the utterance as a side conversation utterance. The key action may be the use of the directed user's name (as shown) or a predefined gesture that is visibly detected from User 3's video camera stream. For example, user 3 may raise his hand to indicate the cue to initiate the side communication with user 1. The key action may be used as a fallback if the gaze direction of the user is not clearly ascertained, or the user may be prompted by the user device 214 to provide a clear key action.

The media server 202 then processes this information to determine that the utterance is intended as a side conversation directed at user 2. The media server 202 can either insert the utterance as an audible message such as message 224 into user 2's audio stream or convert it to text and display it as message 224 on the display screen of user 2's user device 2 10, depending on the chosen implementation.

Additionally, the media server 202 can provide visual indicators on the users' screens to assist them in understanding which participant they are looking at and who will receive their side conversation utterances. In the example, a visual indicator 220 indicates that user 3 is looking at the face of user 2 on the display of user device 214. This feature helps ensure that side conversations are directed accurately and enhances the overall user experience during the multi-party video call. Any suitable visual indicator 220 may be used such as a circle overlaid on the image, a blurring of a portion of the image, a highlighting of the image, etc. In embodiments, the visual indicator 220 may be displayed only when the system 200 determines reliably which zone or which user is in the gaze zone of the user. While this indicator exists, user 1 speaks an utterance that is directed only to the other user that is within the gaze zone.

FIG. 2C is a block diagram illustrating a second example, non-limiting embodiment of a system 230 functioning within the communications network 125 of FIG. 1 in accordance with various aspects described herein. The system 230 includes a media server 232 connected to a media content database 236 and a user database 234. The system 230 in the illustrated example, implements a video call between two users designated as user 1 and user 2. User 1 is associated with a user device 238, and user 2 is associated with user device 240. Each user device is equipped with a respective media app. Thus, user device 238 includes media app 238a and user device 240 includes media app 240a. The media apps cooperate with the media server 232 to implement a video calling service. The service may be offered or provided on a subscription basis to users.

The media server 232 is responsible for managing the media streams and interactions between users during a multi-party video call. The media server 232 is connected to the media content database 236, which stores various media assets, such as video segments, audio clips, and other multimedia content that can be used during the video call. The user database 234 maintains records of user preferences and settings, including configurations for masking inattention events and undesired expressions. The media server 232 continuously analyzes the video stream from User 1's device 238 to detect facial expressions and eye gaze orientation us user 1 during usage of the user device 238. The media server 232 stores segments of the video stream in the media content database 236.

Thus, in accordance with this exemplary embodiment, User 1 may be equipped with a communication device that is networked such as a smart phone, computer, gaming console, or other device. The device may be equipped with a media app such as media app 238a. The media app may be any type of application that enables the user to generate a real life or virtual (such as an avatar) representation of themselves via a media server such as the media server 232 to another one or more users. For example, the media app may be a video calling app, conferencing app, a virtual reality game app, or other similar application. User 2 may be similarly equipped with a user device such as user device 240 and media app such as media app 240a. In this manner, User 2 is able to receive for presentation either a real life or virtual representation of user 1. The media apps are in communication with the media server 232 and the media server 232 is also in communication with the media content database 236 and the user database 234.

As indicated, in one embodiment, the media apps may be used for a video calling service, which may be offered by a service provider. In this example, the media representation created by User 1 using the media app may include an audio stream and a video stream of a real time representation of User 1. The media presentation is sent via the media server 232 to user 2's media app 240a on user device 240 for presentation on user 2's user device 240.

For example, the media server 232 may store a segment as a segment representing attentive listening by user 1. This stored segment can be used to replace portions of the video stream where user 1's attention may wane or be distracted, ensuring a consistent and attentive representation of user 1 to user 2 on user device 240. Thus, while conducting the session, the video stream of user 1 along with the accompanying audio may be analyzed by the media server 232 on a continuous basis. The media server 232 may continually analyze user 1's facial expressions and eye gaze orientation using any suitable techniques. In doing so, the media server may estimate at any point in time an emotion conveyed by user 1's facial expression and the direction of user 1's gaze.

Furthermore, the media server 232 may store a segment of the video stream from user 1. During the duration of the segment, the media server 232 determines that User 1 maintains substantially the same facial expression and eye gaze orientation. Therefore, the media server 232 can save in the media content database 236 a segment of the stream that represents, for instance, a neutral expression with attentive gaze towards the camera. This segment of the stream may be saved with meta-data indicating its nature for subsequent retrieval. In the example of FIG. 2C, the video segment having a time duration 01:23:10 through 01:23:25 is saved in the media content database 236.

FIG. 2D is a block diagram illustrating an example, non-limiting embodiment of a method of operating the system of FIG. 2C, focusing on the detection and substitution of inattentive expressions. The media server 232 detects an inattention event based on User 1's gaze orientation or partial visibility on the screen. For example, due to inattention or distraction, User 1's gaze as captured in the video stream from the media app 238a is directed away from the screen. In another example, User 1 may be only partially visible in the image captured by the camera of the user device 238 because of a distraction.

In cases where User 1 is distracted, inattentive or otherwise appears less than fully attentive to the video call, the media server 232 identifies this as an inattention event. Upon detecting the inattention event at 242, the media server 232 consults the user database 234 to determine if User 1 has an active configuration setting to mask inattention events. If such a setting is active, the media server 232 retrieves the attentive listening segment previously stored in the media content database 236 (illustrated in conjunction with FIG. 2C) and inserts the attentive listening segment in real-time, replacing the inattentive segment. Any suitable video smoothing processing may be performed to make the presentation appear seamless to other participants such as User 2. This ensures a smooth presentation of User 1's media to User 2 on user device 240, maintaining the appearance of attentiveness throughout the video call.

The media server 232 continuously monitors the video stream from User 1's device 238 to detect any changes in facial expressions or gaze orientation. When an inattention event is detected, the media server 232 retrieves a pre-stored segment of the video stream that represents attentive listening from the media content database 236. This segment is then inserted into the live video stream, replacing the portion where User 1's attention waned. This process ensures that User 1 appears attentive to User 2 on device 240, enhancing the overall user experience during the multi-party video call.

FIG. 2E is a block diagram illustrating a second exemplary, non-limiting embodiment of a method of operating the system 230 of FIG. 2C, focusing on the detection and substitution of undesired facial expressions. At 244, the media server 232 detects an undesired expression, such as an eye roll, based on User 1's facial representation. The media server 232 continuously analyzes the video stream from User 1's device 238 to detect any undesired expressions. For example, if User 1 rolls their eyes, the media server 232 identifies this as an undesired expression. Upon detecting the undesired expression, the media server 232 consults the user database 234 to determine if User 1 has an active configuration setting to mask such expressions. If such a setting is active, the media server 232 retrieves the attentive listening segment from the media content database 236 and inserts it in real-time, replacing the undesired expression. This ensures that User 1's media presentation to User 2 on device 240 remains neutral and attentive, enhancing the overall user experience during the multi-party video call.

The media server 232 can be configured to detect a variety of undesired expressions, such as frowns, smirks, or other facial expressions that may be deemed inappropriate or distracting during a video call. When an undesired expression is detected, the media server 232 retrieves a pre-stored segment of the video stream that represents a neutral or attentive expression from the media content database 236. This segment is then inserted into the live video stream, replacing the portion where the undesired expression occurred. This process ensures that User 1's media presentation to User 2 on device 240 remains professional and appropriate, enhancing the overall user experience during the multi-party video call.

In embodiments, the media server 232 may implement an artificial intelligence (AI) or machine learning (ML, collectively, AI/ML) process to monitor and predict the visual appearance of a call participant such as User 1. The AI/ML process may identify a baseline or attentive appearance of the call participant, including facial expression, posture, sitting position, etc. User 1 may define rules for what corresponds to an attentive appearance. The process may be interactive, in that User 1 may be able to specify appearances that should be modified or replaced with the baseline, attentive appearance. These appearances may be added to a blacklist of appearances to be automatically replaced by the AI/ML process. Data describing the blacklist of appearances may be stored in the media content database 236 for subsequent access and pattern matching, perhaps as part of the subscription information for User 1. Moreover, the defined baseline or attentive appearance may be updated during the course of the call, such as if the User 1's appearance changes significantly, such as due to a change of clothes or mussed hair. The media content server 236 may automatically detect the variation and determine if it is significant enough to re-record the attentive listening content for selected playback.

Further, during a live call, the image presented to other call participants such as User 2 may be fed back to User 1 so that User 1 knows when her inattention, distraction or other blacklist appearance is being replaced in the image shown to User 2. User 1 can thus see that, while she is actually making faces such as eye rolls, she is not being presented that way. Rather, she is being presented as normally attentive during the video call. This feedback self-view may be presented, for example, in a small self-view window on the display screen of the User 1 user device 238.

FIG. 2F illustrates a third exemplary, non-limiting embodiment of a method of operating the system 230 within the communications network 125 of FIG. 1. The system 200 includes a media server 232 connected to media content database 236 and user database 234. User 1 is associated with user device 238, and User 2 is associated with user device 240. Each user device is equipped with a respective media app, including media app 238a and media app 240a. The media server 232 continuously analyzes the video stream from User 1's device 238 to detect facial expressions and eye gaze orientation. The media server 232 stores segments of the video stream in the media content database 236, such as a segment representing attentive listening.

FIG. 2F illustrates a multi-party environment, where more than just two participants are involved in a video call. In this example, user 1 sees four other participants displayed on the screen of her user device 238. One of the participants is User 2, who sees other participants as well. In the example, User 1 initiates a side conversation with User 2 to inquire, via an utterance 249, “Ella, want to grab some lunch after this?” The side conversation may be seen or heard by User 2 only, to the exclusion of the other participants on the call.

In this embodiment, User 1's camera is used not only for creating the media stream associated with User 1 but also for determining, via the media app 238a, an orientation of User 1's gaze on the screen of the user device 238. This may be useful in the case of the multi-party embodiment, as illustrated, such that it may be determined by the media app 238a which of multiple users User 1 is looking at. When User 1 looks at User 2's video feed and speaks an utterance such as utterance 249, the media app 238a on User 1's device 238 identifies the gaze direction and the spoken cue. The media app 238a or the media server 232 determines the area of the display screen of the user device 238 at which User 1 is looking. User 1's camera, via the media app 238a, tracks User 1's eye movements and determines a gaze zone indicating a set of coordinates, or a range of coordinates, which represent User 1's focal point at a time t1. At the same time t1, User 1 speaks an utterance 249, as shown. By detecting the direction of the gaze of User 1 toward zone 1 or zone 2 of the display screen of their user device 238, the media app 238a or the media server determines to which other participant in the call, User 2, the side conversation is directed.

Additionally, the media server 232 can provide visual indicators on the users' screens to assist them in understanding which participant they are looking at and who will receive their side conversation utterances. In the example, a visual indicator 220 indicates that user 1 is looking at the face of user 2 on the display of user device 238. This feature helps ensure that side conversations are directed accurately and enhances the overall user experience during the multi-party video call. Any suitable visual indicator 220 may be used such as a circle overlaid on the image, a blurring of a portion of the image, a highlighting of the image, etc.

In addition to, or instead of, detecting the direction of the user's gaze, a key action of the user may be used to distinguish the utterance 249 as a side conversation utterance. The key action may be the use of the directed user's name or a predefined gesture that is visibly detected from User 1's video camera stream. For example, User 1 may raise their hand to indicate the cue to initiate the side communication with User 2. The key action may be used as a fallback if the gaze direction of the user is not clearly ascertained, or the user may be prompted by the user device 238 to provide a clear key action.

The media server 232 then processes this information to determine that the utterance is intended as a side conversation directed at User 2. The media server 232 can either insert the utterance as an audible message into User 2's audio stream or convert it to text and display it on User 2's screen, depending on the chosen implementation.

In the embodiment of FIG. 2F, the media server 232 is responsible for managing the media streams and interactions between users during a multi-party video call. It is connected to the media content database 236, which stores various media assets, such as video segments, audio clips, and other multimedia content that can be used during the video call. The user database 234 maintains records of user preferences and settings, including configurations for masking inattention events and undesired expressions.

Further in the embodiment of FIG. 2F, User 1 and User 2 are each equipped with a user device including user device 238 and user device 240 that includes a media app, including media app 238a and media app 240a. These media apps enable the users to participate in the video call by capturing their video and audio, transmitting it to the media server 232, and receiving and displaying the media streams from other users. In some embodiments, the media apps may also track the users' eye movements and facial expressions to facilitate the detection of inattention events and undesired expressions. The media server 232 continuously monitors the video stream from each user's device to detect any changes in facial expressions or gaze orientation. When an inattention event or undesired expression is detected, the media server 232 may retrieve a pre-stored segment of the video stream that represents attentive listening or a neutral expression from the media content database 236. This segment is then inserted into the live video stream, replacing the portion where the user's attention waned, or the undesired expression occurred. This process ensures that the user's media presentation to other users on other devices remains professional and appropriate, enhancing the overall user experience during the multi-party video call.

FIG. 2G illustrates a third exemplary, non-limiting embodiment of a method of operating a system 250 within the communications network 125 of FIG. 1. The system includes a media server 232 connected to a media content database 236 and a user database 234. User 1 is associated with a user device 252, and User 2 is associated with a user device 254, each equipped with a media app including media app 252a and media app 254a. The media server 232 continuously analyzes the video stream from User 1's user device 252 to detect facial expressions and eye gaze orientation. The media server 232 stores segments of the video stream in the media content database 236, such as a segment representing attentive listening.

In this embodiment, the media app 252a on the user device 252 of User 1 may be a virtual reality app such as a meetings app. A virtual reality (VR) application is a software program that creates an immersive, interactive, and often three-dimensional digital environment. This environment can be explored and interacted with by a user equipped with a suitable device such as wearing a VR headset, which typically includes a display and sensors that track the user's head movements. In this case, there may be two or more participants who are all equipped with virtual reality devices and visual representations of a virtual reality space 255 presented by the media server. The virtual reality space 255 in this example corresponds to a meeting in a conference room in which avatars of the participants are present around a conference table. In the real world, all participants are located remotely from each other. The creation of the virtual reality space 255 and positioning and control of all avatars is done by the media server 232 in response to inputs from user devices of the participants, such as user device 252 of User 1.

In this case, it may be that, rather than masking facial expressions, a user's facial expression may be used to control the visual or audible presentation of an avatar that is representative of the user that created the facial expression. Thus, in the example, the user, identified as Jen, controls an avatar in the virtual reality space 255 also identified as JEN. In the illustrated example, User 1 may create a facial expression that the media server and user database has learned to represent frustration for the user. The media server may detect this while monitoring the video stream from the media app 252a and represent a change to the avatar that represents user 1 that is seen by user 2. For example, a facial expression may change for the avatar of user 1 or another visual indication may be presented on screen associated with the avatar for user 1 and perhaps accompanied by an audible indication as well that is representative of the facial expression emotion detected.

In the example, User 1 at her user device makes a facial expression indicating exasperation or frustration. In the virtual reality space 255, the avatar associated with user 1 is shown with a cloud 256 over the avatar's head, conveying visually to other participants in the virtual reality space 255 what User 1 is thinking or feeling. The media server 232 monitors the video feed from the user device 252 of User 1 and detects the facial expressions of the user. When the media server 232 recognizes the face corresponding to a feeling of frustration, the media server 232 modifies the appearance of the virtual reality space 255 or the appearance of the avatar labelled in JEN in the virtual space to convey the expressed feeling of the user.

The user may pre-record or otherwise establish a menu of facial expressions or gestures that may be stored for reference in the user database 234. The recording may include both audio components as well as visual components for playback. When the user desires to convey a certain feeling or thought or message that corresponds to one of the prerecorded facial expressions or gestures, the user may present that expression or gesture to the camera of the user device 252. The media server 232 will detect the expression or gesture and play back to appropriate response for the avatar in the virtual reality space 255. In embodiments, video smoothing techniques may be used to make the actions or motions of the avatar seem as natural as possible or as desired.

FIG. 2H depicts an illustrative embodiment of a first method 270 in accordance with various aspects described herein. FIG. 2H illustrates method 270 detailing a method of modifying media presentations based on facial analysis within the communications network 125 of FIG. 1.

Method 270 begins with the system receiving a media presentation from the first user, which includes video and audio data, step 271. This step is linked to the media server 232 in FIG. 2C, which manages the media streams from user devices like user device 238 and user device 240. The system then detects the facial representation of the first user in the video portion of the media presentation, step 272. This step involves analyzing the video stream to identify the user's face, similar to the facial analysis performed by the media server 232 in FIG. 2C.

Next, the system identifies a baseline facial representation of the first user for reference, step 273. This reference image is stored in the user database 234, as shown in FIG. 2C. The system continuously analyzes the facial representation of the first user during the media presentation to detect any deviations from the baseline facial representation, step 274.

The system then determines whether a user expression event, such as an inattentive or undesired expression, has been detected, step 275. This decision point determines whether the media presentation needs to be modified. If an expression event is detected, the system modifies the video portion of the media presentation, step 276. This modification involves replacing the detected expression with a pre-stored segment representing a neutral or attentive expression, as described in FIG. 2C. Finally, the system communicates the modified video presentation to the second user, step 278, ensuring that the first user appears attentive and engaged throughout the call. This step is linked to the role of the media server 232 in managing and transmitting the modified media streams.

FIG. 2I depicts an illustrative embodiment of a second method 280 in accordance with various aspects described herein. FIG. 2I illustrates the method 280 for managing side conversations during a multi-party video call within the communication network 125 of FIG. 1. Method 280 begins with the system initiating a multi-party video call involving at least three users, step 281. This step is linked to the overall setup of the communications network 125 in FIG. 1 and the media server 202 in FIG. 2A. The system then communicates the video streams to each user involved in the call, step 282. This involves the media apps 210a, 212a, 214a on the user devices 210, 212, 214, for example, as shown in FIG. 2A.

The system identifies the faces of the users in the video streams, step 283. This step is used for tracking gaze direction and facial expressions, similar to the facial analysis described in connection with FIG. 2C. The system detects a cue from the first user indicating the initiation of a side conversation, step 284. This cue could be a gaze direction or a predefined gesture.

At step 285, the other user is identified, or the user to whom the side conversation is directed. This may be done based on, for example, identifying the user at whom the user is gazing or looking at the user device and determining that the user's gaze direction indicates the intended recipient. This could also be done by the user affirmatively identifying a target user, such as by stating the user's name. Further, in some examples, the method 280 may request confirmation of an intended recipient such as by highlighting that user's image on the user display, presenting the user's name with text and a confirmation message, such as “send message to Sarah?” or any other means.

At step 286, the method 280 detects the side conversation. This may be done, for example, by recording audio of spoken words by the user for playback to the intended recipient. Any other method of conveying the side conversation may be used as well, such as by performing a speech-to-text conversion for display of text on the recipient's user device.

At step 287, the side conversation is conveyed to the recipient user at the user device. Other participants in the call are excluded from the side conversation. In some embodiments, the system may briefly substitute a pre-recorded attentive listening facial image for the user who is the source of the side conversation and the user who is the recipient of the side conversation so that other, excluded participants are not visually aware of the side conversation preparation and reception. Such substituted images may be smoothed into the video and audio presentation so as to be imperceptible.

In view of FIGS. 1, 2A, 2B, and the claims, several alternate embodiments can be applied to the subject matter of the disclosure. One alternate embodiment could involve the integration of augmented reality (AR) features into the media apps 210a, 212a, and 214a. In this embodiment, AR elements could be overlaid on the video feeds to enhance the user experience. For example, visual indicators such as arrows or highlights could be used to show which participant is speaking or to whom a side conversation is directed. This would provide a more intuitive and engaging way for users to follow the conversation dynamics during a multi-party video call.

Another alternate embodiment could involve the use of machine learning algorithms to improve the accuracy of facial expression and gaze detection. The media server 202 or media server 232 could employ advanced machine learning models trained on large datasets to better understand and predict user behavior. This would enhance the system's ability to detect inattentive or undesired expressions and make more accurate modifications to the media presentation. Additionally, the system could learn user-specific preferences over time, allowing for more personalized adjustments.

A further alternate embodiment could involve the use of biometric authentication to enhance security during video calls. The media apps 210a, 212a, and 214a could incorporate facial recognition technology to verify the identity of participants before allowing them to join the call. This would ensure that only authorized users can participate, adding an extra layer of security to the communication.

Another embodiment could involve the integration of voice recognition technology to detect and transcribe side conversations. Instead of relying solely on visual cues like gaze direction, the system could use voice recognition to identify when a user is speaking a side conversation and automatically transcribe it for the intended recipient. This would provide an additional method for managing side conversations, especially in scenarios where visual cues might be ambiguous.

Additionally, an embodiment could involve the use of haptic feedback to provide users with tactile notifications. For example, when a side conversation is directed at a user, their device could vibrate gently to alert them. This would be particularly useful in noisy environments where audio notifications might not be effective.

Another alternate embodiment could involve the use of different types of user devices beyond those shown in FIG. 2A. For instance, the system could be adapted to work with smart glasses, wearable devices, or virtual reality headsets. This would expand the range of devices that can be used for multi-party video calls, providing more flexibility for users.

Lastly, an embodiment could involve the integration of real-time language translation features. The media server 202 or media server 232 could include a translation module that translates spoken language in real-time, allowing participants who speak different languages to communicate seamlessly. This would be particularly beneficial for international video calls, enhancing the system's usability across different regions.

These alternate embodiments demonstrate the versatility and potential enhancements that can be applied to the subject matter of the disclosure, leveraging advanced technologies to improve user experience, security, and functionality in multi-party video calls.

While for purposes of simplicity of explanation, the respective processes are shown and described as a series of blocks in FIG. 2H and FIG. 2I, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

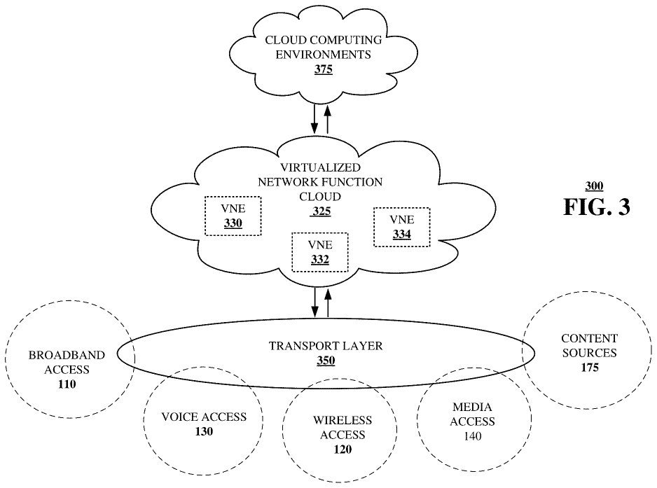

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 200, system 230, system 250, method 270 and method 280 presented in FIGS. 1, 2A, 2B, 2C, 2G, 2H, 2I and 3. For example, virtualized communication network 300 can facilitate in whole or in part conducting spoken side conversations during multi-party video calls by analyzing a user's eye movements to direct the conversation to a specific participant

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

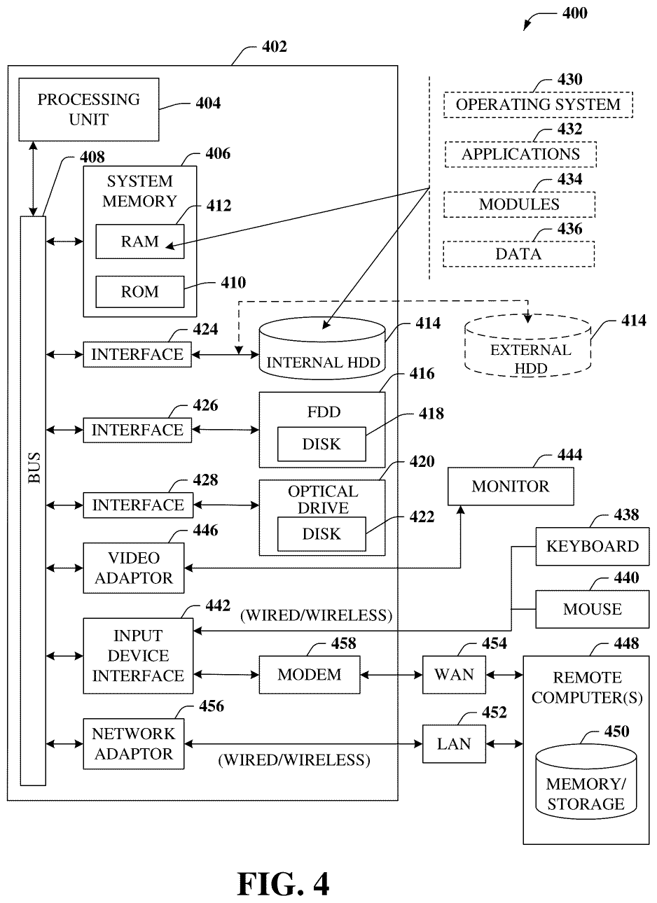

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part conducting spoken side conversations during multi-party video calls by analyzing a user's eye movements to direct the conversation to a specific participant.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

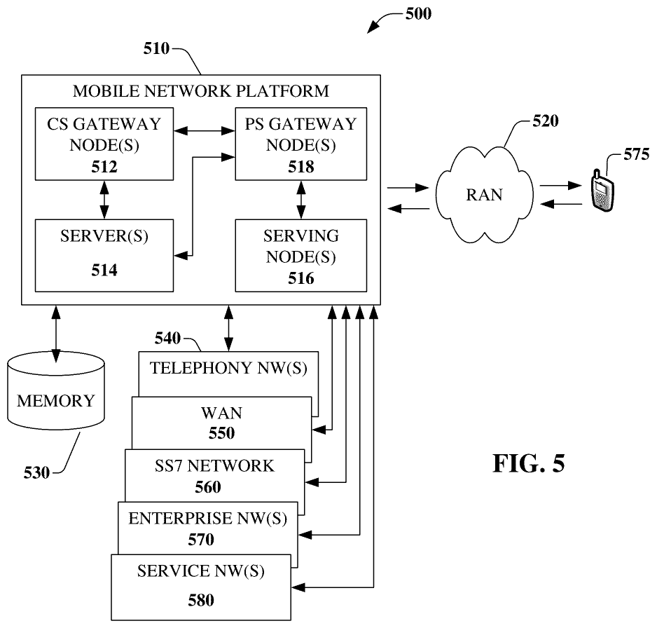

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part conducting spoken side conversations during multi-party video calls by analyzing a user's eye movements to direct the conversation to a specific participant. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

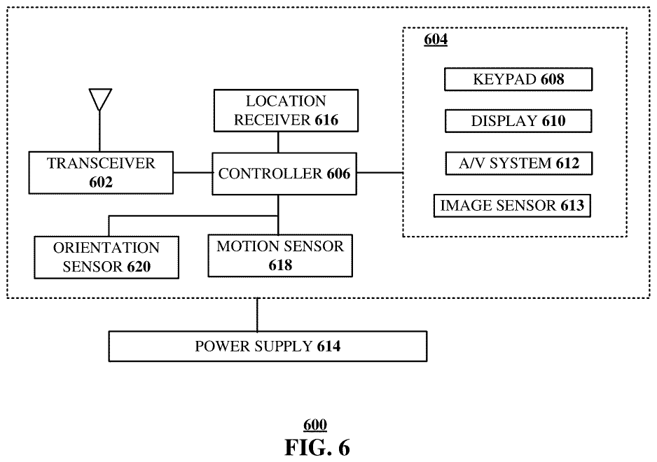

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part conducting spoken side conversations during multi-party video calls by analyzing a user's eye movements to direct the conversation to a specific participant.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
receiving, by a processing system including a processor, a first media presentation of a first user;
identifying, by the processing system, a facial representation of the first user in a video portion of the first media presentation;
analyzing, by the processing system, the facial representation of the first user;
detecting, by the processing system, an event, wherein the detecting the event is based on the analyzing the facial representation of the first user;
determining, by the processing system, a modification of the first media presentation of the first user, wherein the determining the modification is based on the detecting the event;
modifying, by the processing system, the first media presentation of the first user according to the modification, forming a modified media presentation; and
communicating, by the processing system, the modified media presentation to a second user.

2. The method of claim 1, wherein the analyzing the facial representation of the first user comprises:
detecting, by the processing system, a facial expression of the first user.

3. The method of claim 2, wherein the analyzing the facial representation of the first user comprises:
identifying, by the processing system, eyes of the facial representation of the first user; and
detecting, by the processing system, an orientation of the eyes of the facial representation of the first user in relation to a display of a user device of the second user presenting the modified media presentation to the second user.

4. The method of claim 2, wherein the detecting the event comprises:
retrieving, by the processing system, a reference image of the first user from a storage location;
comparing, by the processing system, the facial representation of the first user and the reference image of the first user; and
identifying, by the processing system, the event, wherein the identifying is based on the comparing.

5. The method of claim 4, wherein the identifying the event comprises:
identifying, by the processing system, an inattentive expression of the first user in the first media presentation of the first user.

6. The method of claim 5, further comprising:
retrieving, by the processing system, a standard facial representation of the first user from a storage location; and
substituting, by the processing system, the standard facial representation of the first user for the inattentive expression of the first user in the first media presentation of the first user, forming the modified media presentation.

7. The method of claim 6, comprising:
detecting, by the processing system, an attentive expression of the first user in the first media presentation of the first user; and
storing, by the processing system, data corresponding to the attentive expression of the first user in the storage location for subsequent retrieval as the standard facial representation of the first user.

8. A device, comprising:
a processing system including a processor; and
a memory that stores executable instructions that, when executed by the processing system, facilitate performance of operations, the operations comprising:
initiating a multi-party video call including at least a first user, a second user and a third user;
communicating respective media presentations to a media device of each respective user of the first user, the second user and the third user;
identifying one or more designated portions of a video display of a respective media device of each respective user, each designated portion of the video display presenting a facial representation of another respective user of the first user, the second user and the third user;
detecting a cue of the first user to initiate a communication with the second user, the cue indicating a side conversation utterance from the first user to the second user and excluding the third user; and
communicating information of a side conversation utterance to a media device of the second user.

9. The device of claim 8, wherein the operations further comprise:
determining a gaze zone of a gaze of the first user at the video display of the first user;
associating the gaze zone of the gaze of the first user with the second user or the third user; and
associating the gaze zone of the gaze of the first user with the cue of the first user to initiate a communication with the second user.

10. The device of claim 9, wherein the operations further comprise:
providing, to the media device of the first user, a visual indicator for display on a video display of the media device of the first user, the visual indicator to assist the first user in understanding a determined recipient of the side conversation utterance.

11. The device of claim 10, wherein the providing a visual indicator comprises:
providing a gaze zone indicator on the video display of the first user, the gaze zone indicator corresponding to the gaze zone of a gaze of the first user at the video display of the first user.

12. The device of claim 8, wherein the detecting a cue of the first user to initiate a communication with the second user comprises:
detecting an utterance, by the first user, of a name of the second user.

13. The device of claim 8, wherein the communicating information of the side conversation utterance to a media device of the second user comprises:
providing an audio stream of the multi-party video call to the first user, the second user and the third user; and
providing audio corresponding to the side conversation utterance to the media device of the second user only.

14. The device of claim 8, wherein the operations further comprise:
providing audio data corresponding to the side conversation utterance to the media device of the second user only, the audio data adapted for conversion by the media device of the second user to text for display on a video display of the media device of the second user.

15. The device of claim 8, wherein the operations further comprise:
maintaining a call session database for communication activities, wherein the communication activities include the multi-party video call; and
storing, in the call session database, call session records for participants in the multi-party video call, each respective call session record including:
identification information for a media device of a respective user of the first user, the second user and the third user,
first zone data indicating a first region of the video display of the respective media device on which an image associated with a first other participant in the multi-party video call is displayed, and
second zone data indicating a second region of the video display of the respective media device on which an image associated with a second other participant in the multi-party video call is displayed.

16. A non-transitory machine-readable medium, comprising executable instructions that, when executed by a processing system including a processor, facilitate performance of operations, the operations comprising:
receiving a first media presentation of a first user;
identifying a facial representation of the first user in a video portion of the first media presentation;
identifying a baseline facial representation of the first user for storage as a reference image of the first user;
analyzing the facial representation of the first user during presentation of the first media presentation;
identifying an event in the presentation of the first media presentation, wherein the identifying the event is based on the analyzing the facial representation of the first user;
based on an identification of the event, modifying the video portion of the first media presentation, forming a modified media presentation; and
communicating the modified media presentation to a second user.

17. The non-transitory machine-readable medium of claim 16, wherein the operations further comprise:
presenting one or more images of the facial representation of the first user to a video display of a media device of the first user;
receiving, from the media device of the first user, an indication identifying the baseline facial representation of the first user for storage as the reference image of the first user; and
storing data corresponding to the baseline facial representation of the first user for subsequent retrieval.

18. The non-transitory machine-readable medium of claim 16, wherein the modifying the video portion of the first media presentation comprises:
identifying a characteristic difference between a current image of the first user in the video portion of the first media presentation and the baseline facial representation; and
responsive to the identified characteristic difference, replacing the current image of the first user in the video portion of the first media presentation with the reference image of the first user to form the modified media presentation.

19. The non-transitory machine-readable medium of claim 16, wherein the operations further comprise:
detecting a cue of the first user to initiate a communication with a third user, the cue indicating a side conversation utterance from the first user to the third user and excluding the second user;
detecting, from the first user, the side conversation utterance, wherein the detecting is responsive to the detecting the cue of the first user; and
communicating information of the side conversation utterance to a media device of the third user.

20. The non-transitory machine-readable medium of claim 19, wherein the operations further comprise:
determining a gaze zone of a gaze of the first user at a video display of the first user during the first media presentation of the first user;
associating the gaze zone of the gaze of the first user with the second user or the third user; and
associating the gaze zone of the gaze of the first user with the cue of the first user to initiate a communication with the third user.
